(19) United States
(12) Patent Application Publication
(10) Pub. No.: US 2024/0426783 A1
(43) Pub. Date: Dec. 26, 2024

(54) Vibrational Measurement Assembly for Determining Multiphase Fluid Properties

(71) Applicant: Saudi Arabian Oil Company, Dhahran (SA)

(72) Inventors: Mokhtarudin Abdul Razak, Dhahran (SA); Yaqoub Y. Alramah, Reading (GB); Mohamad Rizal Mohamad Yatim, Abqaiq (SA); Syed Haizir Syed Khuzzan, Udhailiyah (SA)

(21) Appl. No.: 18/750,445

(22) Filed: Jun. 21, 2024

Related U.S. Application Data
(60) Provisional application No. 63/509,692, filed on Jun. 22, 2023.

(51) Int. Cl. G01N 29/036; G01F 1/66

(52) U.S. Cl. CPC G01N 29/036; G01F 1/662; G01N 2291/02433; G01N 2291/02836

(57) ABSTRACT

A burn pit system for non-invasively determining or estimating parameters or properties of a multiphase fluid in a pipeline is disclosed. The burn pit system includes an assembly mounted on an exterior of a pipeline. The assembly includes an oscillator and first vibration senso, both arranged on a first axis, and a second vibration sensor arranged on a second axis. The second axis is perpendicular to the first axis. The oscillator is operable to oscillate the first and second vibration sensors at a predetermined frequency. The system further includes a computing sub-system having a controller, one or more processors, and a non-transitory computer-readable medium storing instructions executable by the one or more processors to perform operations. The operations include transmitting instructions to the oscillator to oscillate at the predetermined frequency and receiving vibration data from the first and second vibration sensors.

### CROSS-REFERENCE TO RELATED PATENT APPLICATION

This application claims the benefit of priority to U.S. Provisional Application No. 63/509,692 on Jun. 22, 2023, the contents of which are incorporated herein.

### TECHNICAL FIELD

The present disclosure relates to a system with sensor arrangement for non-invasively determining parameters of a multiphase fluid.

### BACKGROUND

Hydrocarbon extraction operations can produce combustible waste products as a result of unexpected hydrocarbon production spikes or untreatable waste fluids. Waste management systems for combustible waste products can include flaring systems and burn pit systems. Gas flaring allows operators to de-pressurize their equipment and manage unpredictable and large pressure variations by burning any excess gas. Burn pits are employed when oily or excess liquid hydrocarbons are unsuitable for processing or treatment. The waste product combusted in a burn put can be a two-phase fluid, both liquid and gas.

### SUMMARY

In certain aspects, a burn pit system includes an assembly mounted on an exterior of a pipeline containing a fluid. The assembly includes an oscillator arranged on a first axis, a first vibration sensor arranged on the first axis, and a second vibration sensor arranged on a second axis. The oscillator is operable to oscillate the first vibration sensor at a predetermined frequency and to oscillate the second vibration sensor at a predetermined frequency. The second axis is perpendicular to the first axis. The oscillator is operable. The system further includes a computing sub-system having a controller, one or more processors, and a non-transitory computer-readable medium storing instructions executable by the one or more processors to perform operations. The operations include transmitting instructions to the oscillator to oscillate at the predetermined frequency and receiving vibration data from the first and second vibration sensors.

In some systems, the operations further include determining a measured vibrational amplitude based on the vibration data. In some embodiments, the operations further include determining a gas volume fraction based on the measured vibrational amplitude. The operations can further include determining a liquid flow rate based on the measured vibrational amplitude.

In some systems, the computing sub-system further comprises a memory having a correlation data set. The correlation data set can include a set of vibrational amplitudes and corresponding liquid flow rates of a multiphase fluid. In some embodiments, the correlation data set has a set of vibrational amplitudes and corresponding gas volume fractions.

Some systems further include the pipeline having a cross section with a center, an interior, and an exterior. The fluid may be configured to flow in the interior of the pipeline along a third axis, which is perpendicular to the first axis and perpendicular to the second axis. The oscillator can be mounted to the exterior of the pipeline on the first axis. The first axis passes through the center of the cross section of the pipeline. Some first sensors are mounted on the exterior of the pipeline, on the first axis and are configured to measure a first vibrational amplitude. Some second sensors are mounted on the exterior of the pipeline on the second axis. In some systems, the second axis passes through the center of the cross section of the pipeline. The second sensor can be configured to measure a second vibrational amplitude.

In some systems, the vibration data contains at least a vibrational amplitude from the first sensor and/or contains at least a vibrational amplitude from the second sensor.

In some systems, the first sensor is configured to measure a first vibrational amplitude. The second sensor can be configured to measure a second vibrational amplitude. The first and/or second vibrational amplitudes are acceleration units or velocity units.

In certain embodiments, a burn pit system includes a pipeline for flowing a multiphase hydrocarbon fluid to a burn pit, a pilot arranged on an end of the pipeline, the pilot configured to ignite the multiphase fluid, and an assembly. The assembly includes an oscillator arranged on a first axis, a first vibration sensor arranged on the first axis and a second vibration sensor arranged on a second axis. The oscillator is mounted to an exterior of the pipeline and is operable to vibrate the pipeline at a predetermined frequency. The first vibrational sensor is mounted to the exterior of the pipeline and is operable to measure a first vibrational amplitude of the pipeline during vibration. The second axis is perpendicular to the first axis. The second vibrational sensor is operable to measure a second vibrational amplitude of the pipeline during vibration.

In some systems, the flow direction of the multiphase fluid is perpendicular to the first axis and perpendicular to the second axis.

In some systems, the measurement assembly further includes at least one of: a temperature sensor, a pressure sensor, an acceleration sensor, a displacement sensor, a velocity sensor, a specific gravity sensor, and a seismic sensor.

In some systems, the first axis and the second axis pass a center of a cross section of the pipeline.

Some systems also include a third sensor. The first sensor, second sensor, and third sensor may be arranged equidistant relative to each other or the first sensor, second sensor, third sensor, and oscillator may be arranged equidistant relative to each other.

Some systems also include a third and a fourth sensor. The first sensor, second sensor, third sensor, and fourth sensor may be arranged equidistant relative to each other or the first sensor, second sensor, third sensor, fourth sensor, and oscillator are arranged equidistant relative to each other.

In some systems, the oscillator is operable to oscillate the pipeline at about 10 Hz to about 10 kHz.

In certain embodiments, an assembly includes an oscillator arranged on a first axis, a plurality of sensors mounted to the pipeline, and a computing sub-system. The oscillator is mounted to a pipeline flowing a multiphase fluid. The plurality of sensors includes a first vibration sensor arranged on the first axis, and a second vibration sensor arranged on a second axis. The second axis is perpendicular to the first axis. The computing sub-system includes a controller, one or more processors, and a non-transitory computer-readable medium storing instructions executable by the one or more processors to perform operations. The operations include transmitting instructions to the oscillator to oscillate at the predetermined frequency, receiving vibration data from the first and second vibration sensors, determining a vibrational amplitude based on the vibration data from the first and second sensors of the plurality of sensors, and determining a gas volume fraction of the multiphase fluid based on the vibrational amplitude.

In some assemblies, the multiphase fluid is a hydrocarbon multiphase fluid.

In some assemblies, the multiphase fluid has a liquid component with a liquid flow rate and a gas component with a gas flow rate. The gas flow rate may be greater than the liquid flow rate. The operations can also include determining a liquid flow rate of the liquid component of the multiphase fluid, based on at least the vibrational amplitude. In some embodiments, the operations include determining a volumetric liquid flow rate based on the determined liquid flow rate.

In some assemblies, the operations further comprise determining a volumetric liquid flow rate based on the vibrational amplitude.

In certain aspects, an assembly includes an oscillator arranged on a first axis, a plurality of sensors mounted to the pipeline, and a computing subsystem. The oscillator is mounted to a pipeline flowing a multiphase fluid. The, the plurality of sensors includes a first vibration sensor arranged on the first axis, a second vibration sensor arranged on a second axis. The second axis is perpendicular to the first axis. The computing sub-system includes a controller, one or more processors, and a non-transitory computer-readable medium storing instructions executable by the one or more processors to perform operations. The operations include transmitting instructions to the oscillator to oscillate at the predetermined frequency, receiving vibration data from the first and second vibration sensors, determining at least one vibrational amplitude based on the vibration data from the first and second sensors of the plurality of sensors, and determining a liquid flow rate of a liquid component of the multiphase fluid, based on the vibrational amplitude.

The multiphase fluid can be a hydrocarbon multiphase fluid.

In some assemblies, the multiphase fluid has the liquid component with the liquid flow rate and a gas component with a gas flow rate. The gas flow rate may be greater than the liquid flow rate.

In some assemblies, the operations further include determining gas volume fraction, based on at least the vibrational amplitude. Some operations also include determining the a liquid flow rate based on the determined liquid flow rate.

In some assemblies, the operations further include determining a volumetric liquid flow rate based on the vibrational amplitude.

In certain aspects, an assembly includes an oscillator arranged on a first axis, a plurality of sensors mounted to the pipeline, and a computing subsystem. The oscillator is also mounted to a pipeline flowing a multiphase fluid. The plurality of sensors includes a first vibration sensor arranged on the first axis, a second vibration sensor arranged on a second axis, and a third sensor operable to generate status data. The second axis is perpendicular to the first axis. The computing sub-system includes a controller, one or more processors, and a non-transitory computer-readable medium storing instructions executable by the one or more processors to perform operations. The operations include receiving status data from the plurality of sensors, determining frequency based on the status data, and transmitting instructions to the oscillator to oscillate at the frequency.

The details of one or more embodiments are set forth in the accompanying drawings and the description below. Other features, objects, and advantages will be apparent from the description and drawings, and from the claims.

### DESCRIPTION OF DRAWINGS

FIG. 1 is a view of a burn pit system.

FIG. 2 is a cross-sectional front view of a pipeline of the system and measurement assembly mounted on an exterior of the pipeline.

FIG. 3 is a cross-sectional side view of the pipeline and measurement assembly.

FIGS. 4A and 4B are cross-sectional front views of the pipeline and assembly as an oscillator of the measurement assembly vibrates the pipeline at a predetermined frequency.

FIG. 5 is a flow chart of a method for determining a volumetric flow rate of a multiphase fluid flowing in a burn pit system.

Like reference symbols in the various drawings indicate like elements.

### DETAILED DESCRIPTION

This disclosure relates to a system for non-invasively determining properties of a multiphase fluid as the multiphase fluid flows in a pipe, or pipeline. The system includes a mountable assembly, for example a vibration assembly, measurement assembly, or oscillation assembly, having an oscillator, a parallel (vertical) vibration sensor, and a perpendicular (horizontal) vibration sensor. The mountable assembly is non-invasive and simple to install and remove from an exterior of the pipeline. Additionally, the mountable assembly can quantify a liquid volume flowing in a multiphase fluid in challenging flow patterns and at low or atmospheric pressures. For example, in a low-pressure burn pit pipeline where the multiphase fluid flow has a wavy stratified flow, the system can quantify the liquid volume or volumetric liquid flow in the multiphase hydrocarbon waste fluid. As the liquid volume burned in a burn pit is an accounted—for hydrocarbon loss, a burn pit system with the mountable assembly can enhance accuracy when estimating the total accounted and unaccounted hydrocarbon losses. Further, the mountable assembly is non-intrusively installed, thereby reducing or eliminating the need for process shutdowns for installment or maintenance.

The system and/or assembly can be used in a burn-pit system or other combustion based, downstream waste systems, for example a ground flare system or flare stack system. Additionally, the system and/or assembly can be deployed in an upstream, multiphase flowline, low GVF flowlines, and low fluid pressure flow lines. Burn-pit systems typically flow a multiphase fluid of hydrocarbon waste to a combustion location. In general, burn pit pipelines have low or atmospheric pressure. In use in a burn pit system, the oscillator of the assembly oscillates a portion of the pipeline at a known frequency. The vibrations at the frequency are sensed by the parallel vibration sensor and the perpendicular vibration sensor. For example, the parallel and perpendicular vibration sensors may measure displacement from an initial position, velocity, or acceleration. The sensors then transmit the vibration data to a computing sub-system to process and determine a vibrational amplitude (or displacement) of the pipe with the multiphase fluid. This vibrational amplitude at the known frequency correlates to a gas volume fraction (GVF) of the fluid, the flow rate of the gas, and the flow rate of the fluid. The flow rate of the fluid, with the known pipeline size, can then be used to calculate the volumetric flow rate of the liquid and/or the total volume of burned liquid.

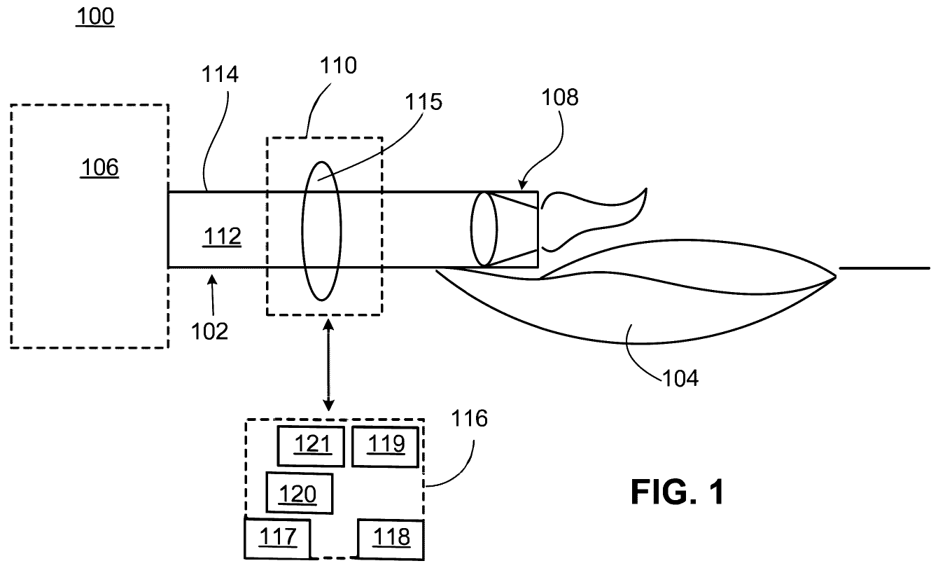

FIG. 1 is a view of a burn pit system 100 having a pipeline 102 connecting a pit 104 to a discharge unit 106. A pilot 108, connected to the pipeline, extends horizontally over the pit 104. The flare pit 104 is generally a shallow depression or pool structure intended to catch and retain any condensates or liquids released from combustion. The discharge unit 106 discharges hydrocarbon multiphase fluids containing a gas/vapor portion and a liquid portion. The discharge unit 106 may be a processing plant, other pipeline, or pumping station. At the pilot 108, the discharged multiphase fluid burns naturally and openly and without smoke suppression or other assistance.

The burn pit system 100 also includes an assembly 110 for measuring and sensing parameters of multiphase fluid flowing in an interior 112 the pipeline 102. The assembly 110 is mounted on, connected to, or attached to an exterior 114 of the pipeline 102 by a clamp configuration. Some assemblies include a housing or structure to mount the assembly onto the exterior of the pipeline. Other assemblies include individual mounts or clamps for components of the assembly to attach to the exterior of the pipeline. In the burn pit system 100, the interior 112 of the pipeline 102 is at about atmospheric pressure. In some systems, the interior of the pipeline has a pressure higher that atmospheric pressure, for example, about 1.1 atm to about 500 atm.

The assembly 110 includes a plurality of sensors 115 and electronically connects to or includes a computer sub-system 116 for analyzing data transmitted by the assembly 110. The computing sub-system 116 includes a computing device (e.g., computer) having a memory 117, a spectrum (spectral) analyzer 118, a controller 119, a transceiver 120, one or more processors 121 and a non-transitory computer-readable medium storing instructions executable by the one or more processors to perform operations. The spectrum analyzer 118 is operable to receive and process data from the assembly 110 and determine a gas volume fraction, gas flow rate, and/or liquid flow rate of the multiphase fluid measured by the assembly 110. In some system, the computing sub-system is part of the assembly and at least part of the assembly is mounted on the exterior of the pipeline. The assembly 110 includes or is connected to a power source 123 operable to power the assembly 110.

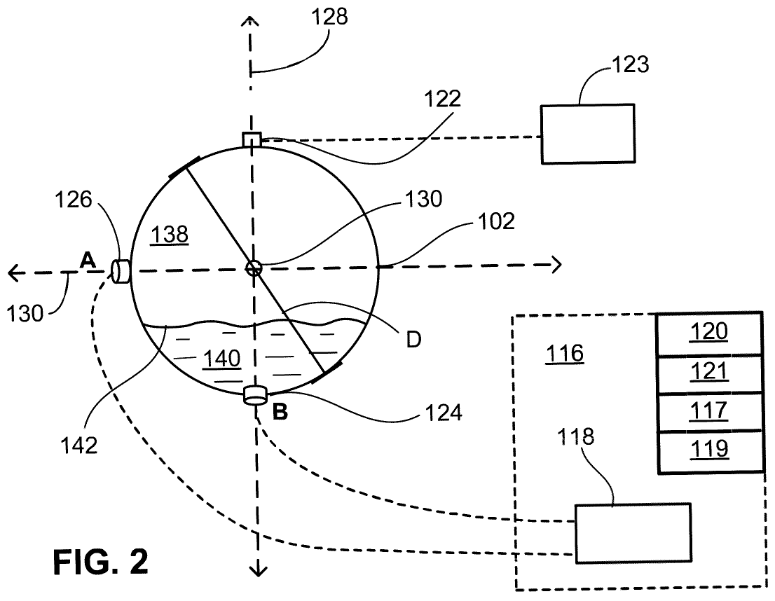

FIG. 2 is a cross-sectional front view of the pipeline 102 of the burn pit system 100 and the assembly 110 mounted on the exterior 114 of the pipeline 102. The assembly 110 includes an oscillator 122 and the plurality of sensors 115, which includes a first (vertical) sensor 124 and a second (horizontal) sensor 126. The first and sensors can be oscillation sensors, vibration sensors, or seismic sensors. The oscillator is operable to oscillate the pipeline at about 1 Hz to about 30 kHz, for example, e.g., about 20 Hz to about 20 kHz, about 10 Hz to about 10 kHz, about 10 Hz to about 100 Hz, about 100 Hz to about 1 kHz, about 1 kHz to about 10 KHz, about 10 kHz to about 20 kHz, about 20 kHz to about 30 kHz, about 1 Hz to about 50 Hz, about 100 Hz to about 500 Hz, about 500 Hz, to about 1 kHz, about 1 kHz to about 5 kHz, about 1 kHz to about 10 kHz, about 20 Hz to about 1 kHz, about 20 Hz, to about 10 kHz, about 30 Hz to about 1 kHz, about 500 Hz to about 20 kHz, or about 1.5 kHz to about 7.5 kHz. In some systems, the oscillation frequency is about 20 Hz, about 63 Hz, about 200 Hz, about 632 Hz, about 2 kHz, about 6.325 kHz, or about 20 kHz. In some systems, the vibration measurements taken by the vibration sensors are repeated five times, ten times, twenty times, thirty times, or fifty times generate a set of measurements in the vibration data. In some systems, a measurement by a vibrational sensor is taken over about 1 seconds to about 20 minutes, e.g., about 0.01 seconds, about 0.5 seconds, about 1 second, 2 seconds, about 3 seconds, about 4 seconds, about 5 seconds, about 10 seconds, about 15 seconds, about 20 seconds, about 25 seconds, about 30 seconds, about 45 seconds, about 1 minute, about 5 minutes, about 10 minutes, about 30 minutes, or about 1 hour.

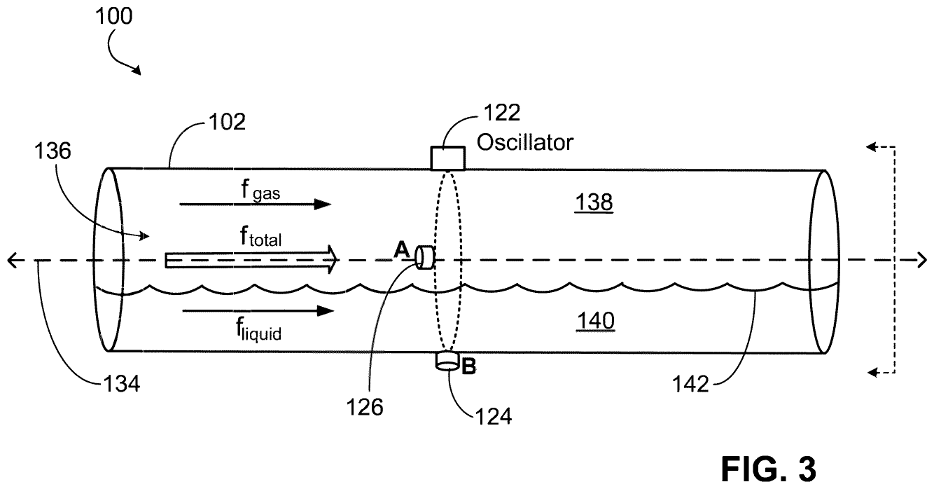

The oscillator 122 is arranged on a first axis 128. The first axis 128 passes through the center 130 of a cross section of the pipeline 102. The first sensor 124 is also arranged on the first axis 128 and is aligned with the oscillator 122. The first sensor 124 is distanced from the oscillator 122 by a diameter D of the pipeline 102. A second axis 130 passes through the center 131 of the cross section of the pipeline 102 and is perpendicular to the first axis 128. The second sensor 126 is arranged on the second axis 132. A third axis 134 (FIG. 3) passes through the center 131 of the cross section of the pipeline 102 and is parallel to the flow direction of a multiphase fluid 136 flowing in the interior 112 of the pipeline 102. The pipeline 102 is centered on the third axis 134 (FIG. 3). In the system 100, the third axis 134 (FIG. 3) is perpendicular to both the first axis 128 and the second axis 132.

Some assemblies include a controller and/or a transceiver in the oscillator, first sensor, and/or second sensor. In addition, some plurality of sensors include more than two sensors, for example, three, four, or five sensors arranged evenly (e.g., equidistant), or unevenly around the pipeline. In some systems, the sensors and oscillator are arranged evenly (equidistant) or unevenly around the exterior of the pipeline. Some assemblies include sets of a plurality of sensors arranged along the pipeline in the direction of the multiphase fluid flow. Each set of a plurality of sensors can have a corresponding oscillator mounted on the pipeline.

The plurality of sensors can be vibration or seismic sensors, for example, displacement sensors, acceleration sensors, or velocity sensors. The plurality of sensors measure acceleration over time. The acceleration measurement can be integrated to calculated velocity. The velocity calculation can then be further integrated to obtain a displacement or vibrational amplitude. In some assemblies, for example assemblies vibrating at a lower frequency (e.g., between about 10 Hz and about 1 kHz), the plurality of sensors can measure the velocity over a time period. The first and/or second sensors can measure the vibration in mm/sec, inch/sec², mm/sec², or inch/sec².

FIG. 3 is a cross-sectional front view of the pipeline 102 and measurement assembly 110. The multiphase fluid 136 has a total flow rate of fₜₒₜₐₗ in a direction parallel with the third axis 134. The multiphase fluid 136 has a gas (vapor) component 138 and a liquid component 140 which abut at an interface 142. The nature of the hydrocarbon multiphase fluid 136 results in a stratified flow, in which a gas (vapor) component 138 and a liquid component 140 separate in the pipeline 102 and abut at an interface 142. In addition, the gas component 138 has a flow rate of f_{gas} and the liquid component 140 has a flow rate of f_{liquid}. The liquid flow rate f_{liquid} is less than the gas flow rate f_{gas}. Due at least partially to the difference flow rates f_{gas}, f_{liquid}, the interface 142 is unstable, resulting in a wavy, stratified multiphase fluid 136 flow pattern. The liquid flow rate f_{liquid} and the gas flow rate f_{gas} each influence the multiphase fluid flow rate fₜᵢₜₐₗ proportional to the gas volume fraction (GVF) and liquid volume fraction (LVF).

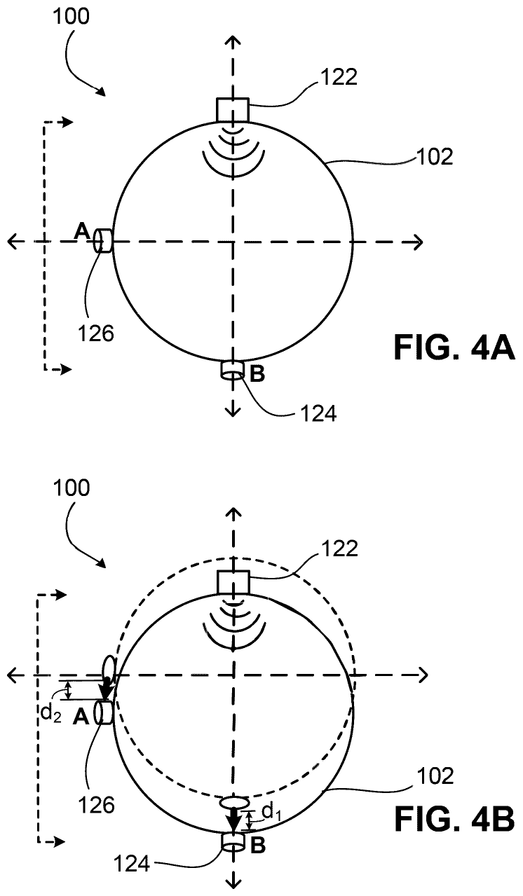

FIGS. 4A and 4B are cross-sectional front views of the pipeline 102 and assembly 110 as the oscillator 122 of the assembly 110 vibrates the pipe 102. Initially, the pipe 102 is static and in an initial position. Thus, both the first and second sensors 124, 126 are in an initial position. (FIG. 4A). Upon receiving a signal from the computing sub-system 116, controller, or operator, the oscillator 122 begins to oscillate or vibrate the pipe 102 at a known frequency, for example 10 kHz. The first sensor 124 is displaced by a value d1 and the second sensor 126 is displaced by a value d2. The first and second sensors 124, 126 sense the amplitude of the vibrations by displacement, velocity, or acceleration.

The vibrational amplitude of the first sensor and the vibrational amplitude of the second sensor, together, correlate to a gas volume fraction (GVF) of the fluid, the flow rate of the gas, and the flow rate of the fluid. This is because the weight, mass, and/or density of the total fluid in the measured portion of the pipeline is inversely proportional to the displacement, velocity, and/or acceleration of the pipe during oscillation. For example, a heavier pipe (e.g., a pipe carrying a multiphase fluid with a higher liquid content) if oscillating at a specific frequency would have a less vibrational intensity (e.g., a pipe with a higher gas content) oscillating at the same frequency. The vibrational intensity is proportional to vibrational amplitude. Similarly, the vibration of pipe (e.g., at 1 mm/sec²) is proportional to the vibration of the fluid. Thus, in general, the higher the GVF in the multiphase fluid, the higher the vibrational amplitude or vibrational intensity, when the frequency is uniform. Using the (first, vertical) amplitude measured by the first sensor and the (second, horizontal) amplitude measured by the second sensor, a unique waveform or similar data structure is generated by the spectrum analyzer based on the first and second amplitudes. The unique waveform at the known frequency correlates to a gas volume fraction which can then be used to determine the fluid volume fraction and the fluid rate. The flow rate of the multiphase fluid, with the known pipeline size, can then be used to calculate the volumetric flow rate of the liquid and/or the total volume of burned liquid.

In some embodiments, the spectrum analyzer compares the unique waveform, or dataset, generated by at least one of the first and second amplitudes to a set of test waveforms, or test data sets, saved in a memory of the computer sub-system, spectrum analyzer or in a memory of the assembly. In some cases, the test waveforms are generated prior to measuring the vibrations of the pipe using the assembly. Some test waveforms are generated at known GVFs, known liquid flow rates, and known frequencies.

In some systems, the first amplitude is analyzed by the spectral (spectrum) analyzer to determine the GVF. For example, the spectrum analyzer may generate a plot of the measured or calculated vibrational amplitude generated by the first sensor of the assembly over time or may identify, calculate, or determine the maximum displacement of the pipeline along the first axis. The measured plot of the first vibrational amplitude or maximum displacement value at the known frequency is then compared to a set of known test plots of first vibrational amplitudes or maximum displacement values at known GVFs and oscillation frequencies. In such a system, the first vibrational amplitude of the test plot or value is measured at the same or similar location relative to the oscillator as the first sensor (e.g., aligned on an axis, distanced by a diameter of the test pipeline).

The second vibrational amplitude generated by the second, horizontal sensor can then be used alone or in combination with the determined GVF and/or first vibrational amplitude to determine the liquid flow rate of the multiphase fluid. The spectrum analyzer may generate a plot of the measured or calculated second vibrational amplitude generated by the second, horizontal sensor over time or may identify, calculate, or determine the maximum displacement of the pipeline along the second axis. The plot or maximum value of the second vibrational amplitude at the determined GVF and known frequency, is then compared to a set of known test plots of the second vibrational amplitude at the known GVFs, frequencies, and liquid flow rates. The spectrum analyzer then correlates the second vibrational amplitude with a liquid flow rate. Where the diameter or size of the pipeline is known, the spectrum analyzer can also estimate the volume of liquid hydrocarbon burned in the burn pit over a period of time.

While a system has been disclosed as using the first vibrational amplitude the determine the GVF then using the second vibrational amplitude and GVF to determine the liquid flow rate, some systems use the second horizontal vibrational amplitude to determine the GVF. Such system can use the first vibrational amplitude with the determined GVF to further determine the liquid volume fraction, the liquid flow rate, and/or estimate the volume of burned liquid hydrocarbon by the burn pit.

While system has been disclosed as using the one of the first or second vibrational amplitude the determine the GVF then using the other of the first or second vibrational amplitude and determined GVF to further determine the liquid flow rate, some systems use the first vibrational amplitude and the second vibrational amplitude to determine the GVF. Such system can use the first vibrational amplitude and/or second vibrational amplitude with the determined GVF to further determine the liquid volume fraction, the liquid flow rate, and/or estimate the volume of burned liquid hydrocarbon by the burn pit.

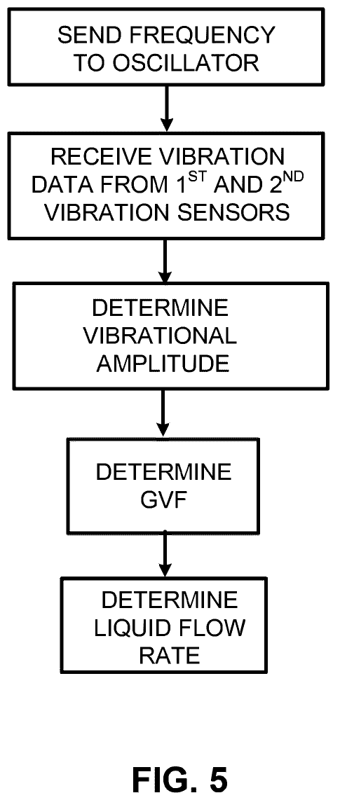

FIG. 5 is a flow chart of a method 200 for determining a volumetric flow rate of a multiphase fluid flowing in a burn pit system. The method 200 is described with reference to the burn pit system 100, however the method 200 can be used with any suitable system. The method 200 includes developing a correlation test table for vibrational amplitudes at a variety of GVFs and flow rates. After development of the correlation test table a user, operator, or computing sub-system determines the predetermined testing frequency. The frequency determination can consider the temperature if the interior of the pipeline, the pressure in the interior of the pipeline, specific gravity, the size of the pipeline, the material of the pipeline, the location of any seams or welding junctions on the pipeline, the temperature of the multiphase fluid, and/or the composition of the fluid, if known.

Once the frequency is determined, the controller, computing sub-system, or operator prompts the oscillator to vibrate a portion of the pipeline at the known frequency and prompts the plurality of sensors to measure the first and second vibrational amplitudes.

The first sensor measures the vertical vibrational amplitude (or vibrational intensity) by measuring the acceleration, velocity, or displacement of the first sensor relative to an initial position of the first sensor. The first sensor is aligned with the oscillator on the first axis such that the first sensor measures acceleration, velocity, or displacement on the first axis. The first sensor then generates first vibration data that contains at least the measured acceleration, velocity, or displacement measured by the first sensor.

The second sensor measures the horizontal vibrational amplitude of the second sensor relative to an initial position. The acceleration, velocity, or displacement is measured along the second axis, such that the measured acceleration, velocity, or displacement of the second sensor is perpendicular to the movement measured by the first sensor. In some cases, the second sensor also measures an acceleration, velocity, or displacement along an axis parallel to the first axis. The second sensor then generates second vibration data that contains at least the measured acceleration, velocity, or displacement measured by the second sensor.

In some embodiments, the second sensor measures the acceleration, velocity, or displacement of the second sensor relative to an initial position within a plane formed by the first axis and second axis. The spectrum analyzer or the second sensor can calculate or measure the acceleration, velocity, or displacement of the second sensor in the direction of the second axis and acceleration, velocity, or displacement of the second sensor in the direction of the first axis, based on the measured acceleration, velocity, or displacement.

The vibration data generated by each of the plurality of sensors includes at least a measured acceleration of the sensor, the velocity of the sensor, and/or the displacement of the sensor over a period of time. Each sensor takes multiple measurements over a period of time to generate a set of measurements. For example, the first sensor may measure an acceleration over a five second period when the sensor is prompted by a controller. The five second measurement is repeated three, five, ten, or twenty times to generate a set of acceleration measurements. The repeated measurements of a sensor combine to form a set of measurements contained in the vibration data. The vibration data can also include the known frequency, the distance between the oscillator and the sensor, and other environmental parameters like pipeline pressure, temperature, or composition of the multiphase fluid. In the system 100, the distance between the first vibration sensor and the oscillator is equal to the diameter of the pipeline (measured at the exterior surface. Other systems may have distances that are greater than a diameter of the pipeline.

The plurality of sensors 115 transmits the collected vibration to the computing subsystem via a transceiver in each if the plurality of sensors or via wired connection. The computing sub-system, or a transceiver thereof, receives the vibration data from the assembly. In some assemblies, each sensor in the plurality of sensors transmits the generated vibration data containing a set of measured acceleration, velocity, or displacement measurements taken by the respective sensor of the plurality of sensors, to a single sensor of the plurality of sensors, the oscillator, or a transceiver of the assembly. The single sensor, oscillator, or transceiver of the assembly then combines the vibration data of each sensor into a vibration data packet and transmits the vibration data packet to the computer sub-system and/or spectrum analyzer.

The controller of the computing sub-system, (e.g., a controller of a computer) initiates a spectrum analyzer of the computing sub-system. The spectrum analyzer may be a non-transitory process or software or may be a separate device containing a non-transitory process or software and connected to a computer for processing the vibration data from the sensors. In some systems, the spectrum analyzer receives the vibration data directly from the plurality of sensors.

In use, the spectrum analyzer processes the vibration data using a processor of the spectrum analyzer or using the one or more processors of the computer sub-system. The spectrum analyzer uses the processed vibration data to determine the vibrational amplitude of the first sensor and the vibrational amplitude of the second sensor for each measurement in the set of measurements. The spectrum analyzer generates a waterfall plot of the amplitude measured over time for the set of measurements of each sensor. For example, where the first sensor measures the acceleration over five seconds, ten times, the waterfall plot produced by the spectrum analyzer can include ten trendlines of the determined vibrational amplitude over time. The spectrum analyzer then generates an amplitude data packet containing at least the determined vibrational amplitude over time for each sensor and transmits the amplitude data packet to the controller or processor of the computer sub-system for further analysis and processing. The spectrum analyzer can further calculate an average vibrational amplitude based on the set of measurements. The transmitted amplitude data packet may include the averaged vibrational amplitude of each sensor and may include the waterfall plot.

The computer subsystem includes a memory or is connected to a memory that contains at least one data bank. The data bank can include a correlation or test table, graph, or data set which correlates a vibrational amplitude at a frequency to a GVF. The computer subsystem also includes a controller, one or more processors, and a non-transitory computer-readable medium storing instructions executable by the one or more processors to perform operations.

The operations include receiving and comparing the measured or determined vibrational amplitudes in the amplitude data packet to known vibrational amplitudes in the correlation table. The controller of the computer subsystem then determines the GVF based on at least one of the measured vibrational amplitudes, for example, the measured parallel vibrational amplitude of the first sensor and/or the measured perpendicular vibrational amplitude of the second sensor. The controller then determines by correlation or calculation the liquid flow rate based on, at least, the determined GVF. The liquid flow rate may also be determined based on the vibration amplitude of the first sensor, vibrational amplitude of the second sensor, environmental parameters (e.g., pressure, temperature, specific gravity, composition of the multiphase fluid), and/or a generated correlation table or data set. In some methods, the controller also determines the volumetric liquid flow of the liquid component of the multiphase fluid or the total volume of the liquid burned over a period of time.

While an assembly with a first sensor and a second sensor has been described, the plurality of sensors includes a more two sensors, for example a third sensor, fourth sensor, and fifth sensor each having a transceiver to send data to the computing sub-system or spectrum analyzer. Sensors of the plurality of sensors may be temperature sensors, capacitance sensors, pressure sensors, seismic sensor, moisture sensors, or other applicable sensors. Where the third, fourth, or fifth sensors are vibration sensors, the spectrum analyzer can use measured data from the third, fourth, and/or fifth sensors to determine and transmit to the controller, a vibrational amplitude of the third, fourth, and fifth sensor, respectively. The controller of the computer sub-system may also determine the GVF and liquid flow rate based on the data generated by the third, fourth, and/or fifth sensors.

In some systems, the third, fourth, and fifth sensors may be status sensors (e.g., a first status sensor, a second status sensor, and a third status sensor) the assembly can transmit status data containing at least the status of the pipeline using the third, fourth, and/or fifth sensors. For example, the status sensors may be temperature sensors, capacitance sensors, pressure sensors, seismic sensor, moisture sensors, or other applicable sensors. The status sensors generate status data that is sent to the controller. The status data can contain measured temperatures, pressure, moistures, humidity, capacitances, vibrations, and/or other parameters of the system or environment (e.g., the air above the formation, the formation, the area adjacent the pipeline, the burn pit, the pilot, the exterior of the pipeline, or the interior of the pipeline).

The status of the pipeline can be used to determine or estimate the oscillation frequency, the GVF, the liquid flow rate, and/or the liquid volume burned by the burn. In such a system, the computing subsystem may contain a non-transitory computer-readable medium storing instructions executable by the one or more processors to perform operations. The operations can include receiving status data from the plurality of sensors, determining frequency based on the status data, and transmitting instructions to the oscillator to oscillate at the frequency.

While an assembly in a burn pit system has been disclosed, the measurement system may be part of, or attached to, other systems for determining a liquid flow rate of a two-phase fluid.

In a burn pit system, the method can also include estimating a volume of liquid combusted by a pilot connected the containment structure based on the determined volumetric liquid flow rate of the fluid.

While the measurement assembly has been described as determining a liquid flow rate of the multiphase fluid, some assemblies determine or calculate other parameters of the multiphase fluid. For example, the assembly may determine pipe flexibility.

While the system has been described as flowing a multiphase hydrocarbon fluid, some systems flow a single-phase fluid. In such an embodiment, the system 100 and method 200 may be used to determine the liquid rate of the single-phase fluid or the gas flow rate of the single-phase fluid. To determine the liquid rate of the single-phase fluid, the GVF is 0%. To determine the gas flow rate of the single-phase fluid, the GVF is 100%.

While a system has been described in the context of a burn pit system, some systems can be used in other industries or applications. For example, the system can be used on pipelines flowing a single or multiphase fluid over a long distance. The mountable assembly, in such an application, may analyze the fluid flow of a multiphase fluid, for example, hydrocarbon fluid, water, brine, or other fluid.

While a method has been described in the context of a burn pit, the method can apply to other systems in the oil and gas industry or industries. For example, a method can include prompting, by a controller of a computer sub-system of a system, an oscillator the system mounted to a containment structure, to oscillate at a predetermined frequency. The containment structure (e.pg., a pipeline, fluid line, fluid tubing, other fluid conduit, or vessel) contains a fluid. The fluid may be a gaseous fluid, a liquid fluid, or a multiphase fluid. The oscillator of the system is mounted onto the containment vessel using individual clamps, a clamping systems, bolts, Velcro, snap fits, magnets, adhesive, or other releasable connector.

The system also includes a plurality of sensors operably connected to the controller and computer sub-system. The plurality of sensors has at least one status sensor operable to generate status data. To determine or estimate a frequency, the controller receives status data from the plurality of sensors. The status data contains at least one of a temperature or pressure measured by a status sensor of the plurality of sensors. In some systems, multiple status sensors measure pressure and temperatures to generate temperatures or pressures over time or over a length or width of the containment structure (e.g., fluid conduit). The status data can contain measured temperatures, pressure, moistures, humidity, capacitances, vibrations, and/or other parameters of the system or environment (e.g., a specific gravity, the area adjacent the containment structure, any inlets or outlets of the containment structure or connected to the containment structure, the exterior of the containment structure, or the interior of the containment structure). The controller then determines or estimates an oscillation frequency, at least partially, based on the status data. In other methods, a user may manually input or elect an oscillation frequency.

The controller then prompts the plurality of sensors of the system mounted to the containment structure to measure a change in acceleration, velocity, or displacement, over a predetermined amount of time, using two vibration sensors. The plurality of sensors includes at least two vibration sensors but may include more than two plurality of sensors in a variety of configurations on the exterior of the containment structure. Each vibration sensors generate and/or measure an acceleration, velocity, or displacement relative to an initial position of each sensor. The measurements, contained in vibration data, are transmitted to a spectrum analyzer by each vibration sensor or are collected then transmitted by a transceiver of the plurality of sensors. The spectrum analyzer may be operably connected to each sensor of the plurality of sensors or a transceiver of the plurality of sensors. For example, the spectrum analyzer may receive vibration data from a first vibration sensor and vibration data from a second vibration sensor or may receive vibration data containing measurements from both the first and second vibration sensors. Additionally, the spectrum analyzer of the system may be part of the computer-sub system, an assembly, or neither.

Where the spectrum analyzer is part of the computer sub-system, the spectrum analyzer may use the components of the computer sub-system to execute any operations. In such a case, the method can include receiving, by a transceiver of the computer sub-system, vibration data from the plurality of sensors. The spectrum analyzer of the computer-sub system then determines a vibrational amplitude associated with each vibrational sensor based on the vibration data from that vibration sensors. For example, the spectrum analyzer may determine a first vibrational amplitude based on vibration data from a first vibration sensor and may determine a second vibrational amplitude based on vibration data from a second vibration sensor. The spectrum analyzer then generates amplitude data containing the determined vibrational amplitudes (e.g., the determined first vibration amplitude and the determined second vibrational amplitude) for each vibrational sensor.

Where a spectrum analyzer is not part of the computer-sub system, the spectrum analyzer is operably connected to the computer sub-system. The spectrum analyzer includes an analyzer controller; one or more analyzer processors, and a non-transitory computer-readable medium storing instructions executable by the one or more processors to perform operations, the analyzer operations. The operations can include receiving vibration data generated by the first and second vibration sensors of the assembly and determining a first vibrational amplitude of the first sensor based on the vibration data generated by the first sensor and a second vibrational amplitude generated by the second sensor. The spectrum analyzer the generates amplitude data containing at least the first and second vibrational amplitudes and transmitting the amplitude data to the computing subsystem. The computer sub-system receives the amplitude data from the spectrum analyzer.

In any configuration, the computer sub-system obtains the amplitude data from the spectrum analyzer which containing at least a vibrational amplitude of each vibration sensor in the plurality of sensors. The controller of the computer sub-system then determines at least one property of a fluid in the containment structure based on the at least one vibrational amplitude of the amplitude data. In some cases, the computer sub-system determines the at least one property of a fluid in the containment structure based vibrational amplitudes of at least two vibration sensors of the plurality of sensors. In some cases, the computer sub-system determines the at least one property of a fluid in the containment structure based all determined vibrational amplitudes associated with measurements from vibration sensors of the plurality of sensors. For example, where a plurality of sensors includes ten vibration sensors, the spectrum analyzer determines a vibrational amplitude for each of the ten vibrational sensors, based on measurements (or set of measurements) taken by each vibrational sensor. The amplitude data set contains ten vibrational amplitudes which are used by the computer sub-system to determine a property of the fluid in the containment structure.

The at least one property may include the liquid flow rate of a liquid component of the fluid, a gas volume fraction, liquid volume fraction, a fluid weight, fluid mass, fluid density, vibration intensity, a flow rate of the gas component of the fluid, a composition of the fluid, a composition of a liquid component of the fluid, a composition of the gas component of the fluid, a gas density of the fluid, a liquid density of the fluid, an internal pressure of the containment structure, an average flow rate, a volumetric fluid rate of the fluid, a volumetric liquid rate of the liquid component of the fluid, a volumetric gas flow rate of the gas component of the fluid, a fluid flow pattern, or a flow pattern (e.g., laminar or turbulent). The liquid flow rate of a liquid component may be based on a determined gas volume fraction. In some system, the volume, shape, and/or cross-sectional area of the containment vessel is known. In some cases, the flow pattern fluid density, mass, and/or composition is known.

A number of embodiments have been described. Nevertheless, it will be understood that various modifications may be made.

What is claimed is:

1. A burn pit system comprising:
a pipeline for flowing a fluid to a burn pit,
a pilot arranged on an end of the pipeline, the pilot configured to ignite the multiphase fluid, and
an assembly comprising:
an oscillator arranged on a first axis, the oscillator mounted to an exterior of the pipeline, the oscillator operable to vibrate the pipeline at a predetermined frequency;
a first vibration sensor arranged on the first axis, the first vibrational sensor mounted to the exterior of the pipeline, wherein the first vibration sensor is operable to measure an acceleration, velocity, or displacement of the first vibration sensor; and
a second vibration sensor arranged on a second axis, wherein the second axis is perpendicular to the first axis, wherein the second vibrational sensor is operable to measure an acceleration, velocity, or displacement of the first vibration sensor.

2. The system according to claim 1, further comprising:
a computing sub-system comprising:
a spectrum analyzer;
a controller; and
one or more processors, a non-transitory computer-readable medium storing instructions executable by the one or more processors to perform operations, the operations comprising:
transmitting instructions to the oscillator to oscillate at the predetermined frequency;
receiving vibration data from the first and second vibration sensors;
determining at least one vibrational amplitude based on the vibration data from the first and second sensors, and
determining a gas volume fraction of the multiphase fluid in the pipeline based on the at least one vibrational amplitude.

3. The system according to claim 2, wherein operations further comprise:
determining a liquid flow rate of a liquid component of the multiphase fluid, based on at least the vibrational amplitude; and
determining a volumetric liquid flow rate of the liquid component of the multiphase fluid in the pipeline based on the determined liquid flow rate.

4. The system according to claim 3, wherein the operations further comprise:
determining a volume of liquid combusted by the pilot connected the pipeline based on the determined volumetric liquid flow rate of the liquid component of the multiphase fluid.

5. The system according to claim 1, further comprising a third sensor and a fourth sensor, wherein the first sensor, second sensor, third sensor, and fourth sensor are arranged equidistant relative to each other.

6. The system according to claim 1, wherein the first sensor is a seismic sensor.

7. The system according to claim 1, wherein the second sensor is a seismic sensor.

8. The system according to claim 1, the predetermined frequency is about 10 Hz to about 10 kHz.

9. An assembly comprising:
an oscillator arranged on a first axis, the oscillator mounted to a pipeline flowing a multiphase fluid,
a plurality of sensors mounted to the pipeline, the plurality of sensors comprising:
a first vibration sensor arranged on the first axis, the first vibration sensor operable to generate and transmit vibration data containing measurements from the first vibration sensor, and
a second vibration sensor arranged on a second axis, the second vibration sensor operable to generate and transmit vibration data containing measurements from the second sensor; wherein the second axis is perpendicular to the first axis; and
a computing sub-system comprising:
a spectrum analyzer;
a controller operable to control the oscillator; and
one or more processors, a non-transitory computer-readable medium storing instructions executable by the one or more processors to perform operations, the operations comprising:
prompting the oscillator to oscillate at a predetermined frequency;
receiving vibration data from the first and second vibration sensors;
determining, by the spectrum analyzer, a first vibrational amplitude based on the vibration data from the first sensor and second vibrational amplitude based on the vibration data from the second sensor; and
determining a liquid flow rate of a liquid component of the multiphase fluid, based on the first and second vibrational amplitudes.

10. The assembly according to claim 9, determining a liquid flow rate of the liquid component of the multiphase fluid, based on at least one of the first and second vibrational amplitudes comprises:
determining a gas volume fraction of the multiphase fluid based on the first and second vibrational amplitudes; and
determining the liquid flow rate of the liquid component of the multiphase fluid based on the determined gas volume fraction.

11. The assembly according to claim 9, wherein the operations further comprise determining a volumetric liquid flow rate based on the determined liquid flow rate.

12. The assembly according to claim 11, wherein the operations further comprise estimating a volume of liquid combusted by a pilot connected the pipeline based on the volumetric liquid flow rate and gas volume fraction.

13. A method comprising:
prompting, by a controller of a computer sub-system of a system, an oscillator the system mounted to a containment structure, to oscillate at a predetermined frequency;
prompting, by the controller, a plurality of sensors of the system mounted to the containment structure to measure a change in acceleration, velocity, or displacement, over a predetermined amount of time, the plurality of sensors having at least two vibration sensors;
obtaining amplitude data containing a vibrational amplitude of each vibration sensor in the plurality of sensors;
determining at least one property of a fluid in the containment structure based on the at least one vibrational amplitude of the amplitude data.

14. The method according to claim 13, wherein determining the at least one property of the fluid in the containment structure based on the at least one vibrational amplitude of the amplitude data, comprises:
determining a liquid flow rate of a liquid component of the fluid, based at least one of the vibrational amplitudes of the amplitude data.

15. The method according to claim 13, wherein determining the at least one property of the fluid in the containment structure based on the at least one vibrational amplitude of the amplitude data, comprises:
determining a gas volume fraction of the fluid, based on at least one the vibrational amplitudes of the amplitude data.

16. The method according to claim 15, wherein determining the at least one property of the fluid in the containment structure based on the at least one vibrational amplitude of the amplitude data, comprises:
determining a liquid flow rate of a liquid component of the fluid, based on the determined gas volume fraction.

17. The method according to claim 16, wherein determining the at least one property of the fluid in the containment structure based on the at least one vibrational amplitude of the amplitude data, comprises:
determining a volumetric liquid flow rate based on the determined liquid flow rate and a known cross-sectional area of the containment structure.

18. The method according to claim 17, wherein the fluid is combustible and wherein determining the at least one property of the fluid in the containment structure based on the at least one vibrational amplitude of the amplitude data, comprises:
estimating a volume of liquid combusted by a pilot connected the containment structure based on the determined volumetric liquid flow rate of the fluid.

19. The method according to claim 13, wherein determining properties of the fluid in the containment structure based on at least one of the first and second measured vibrational amplitudes comprises:
determining gas volume fraction of the fluid, based on a first vibrational amplitude of the amplitude data and a second vibrational amplitude of the amplitude data.

20. The method according to claim 13, wherein the plurality of sensors comprises at least one status sensor operable to generate status data, wherein prompting the oscillator the system to oscillate at a predetermined frequency comprises:
receiving status data from the plurality of sensors, the status data containing at least one of a temperature or pressure measured by the at least one status sensor; and
determining an oscillation frequency based on the status data.
